(19) United States
(12) Patent Application Publication
(10) Pub. No.: US 2022/0097102 A1
(43) Pub. Date: Mar. 31, 2022

(54) SORTING APPARATUS AND SORTING METHOD

(71) Applicant: SEIKO EPSON CORPORATION, Tokyo (JP)

(72) Inventors: Kenta NOMURA, Matsumoto (JP); Shigeo FUJITA, Matsumoto (JP)

(21) Appl. No.: 17/482,506

(22) Filed: Sep. 23, 2021

(30) Foreign Application Priority Data
Sep. 25, 2020 (JP) 2020-161002

(51) Int. Cl. B07C 5/34; B07C 5/342

(52) U.S. Cl. CPC B07C 5/34; B07C 2501/0054; B07C 5/3422; B07C 5/342

(57) ABSTRACT

A sorting apparatus has: a paper supply section that supplies paper; a first sensor that detects a multi-feed of the paper supplied from the paper supply section; a second sensor that detects damage to the paper; a third sensor that detects the paper as an image; first to fourth paper ejection cassettes in which the paper is stacked; and a control section that appropriately ejects the paper to one of the first to fourth paper ejection cassettes according to at least one of detection results from the first sensor, second sensor, and third sensor.

The present application is based on, and claims priority from JP Application Serial Number 2020-161002, filed Sep. 25, 2020, the disclosure of which is hereby incorporated by reference herein in its entirety.

### BACKGROUND

### 1. Technical Field

The present disclosure relates to a sorting apparatus and a sorting method.

### 2. Related Art

A sorting apparatus known in related art sorts used waste paper into a plurality of types of paper according to the state of the paper. For example, JP-A-2004-75283 discloses a sorting apparatus having a magnet roller and color sensors. This sorting apparatus sorts paper on which recording is possible on the rear surface and paper to be used to produce wet recycled paper.

A recycled paper producing apparatus that supplies sheet paper as a material may cause a paper jam. With this type of recycled paper producing apparatus, paper fastened with a fastener and damaged paper having a hole, a break, or the like needs to be removed. Another problem with the recycled paper producing apparatus is that recycled paper produced by it and non-recycled paper need to be separated. However, the sorting apparatus described in JP-A-2004-75283 does not address these problems.

### SUMMARY

A sorting apparatus has: a paper supply section that supplies paper; a first sensor that detects a multi-feed of the paper supplied from the paper supply section; a second sensor that detects damage to the paper; a third sensor that detects the paper as an image; a plurality of mounting sections in which the paper is stacked; and a control section that appropriately ejects the paper to one of the mounting sections according to at least one of detection results from the first sensor, the second sensor, and the third sensor.

A sorting method in which the sorting apparatus described above is used to sort the paper, the method comprising: a paper supply step of supplying the paper; a multi-feed detection step of detecting a multi-feed of the paper supplied from the paper supply section; a damage detection step of detecting damage to the paper; an image detection step of detecting the paper as an image; and a paper ejection step of appropriately ejecting the paper to one of the mounting sections according to at least one of detection results from the first sensor, the second sensor, and the third sensor.

### BRIEF DESCRIPTION OF THE DRAWINGS

FIG. 1 is an external view of a sorting apparatus according to an embodiment, schematically illustrating the structure of the sorting apparatus.

FIG. 2 is a sectional view illustrating the internal structure of the sorting apparatus.

FIG. 3 is a block diagram illustrating electrical coupling among the main sections of the sorting apparatus.

FIG. 4 is a flowchart illustrating a method of sorting by the sorting apparatus.

### DESCRIPTION OF EXEMPLARY EMBODIMENTS

### 1. Embodiment

The structure of a sorting apparatus 100 according to an embodiment will be outlined. In the coordinate system indicated in drawings, two mutually orthogonal virtual axes will be taken as the X axis and Z axis, assuming that the sorting apparatus 100 is horizontally placed. The X axis is parallel to the left and right direction of the sorting apparatus 100. The top of the arrow indicating the X axis is rightward. The Z axis is parallel to the vertical direction. The top of the arrow indicating the Z axis is upward.

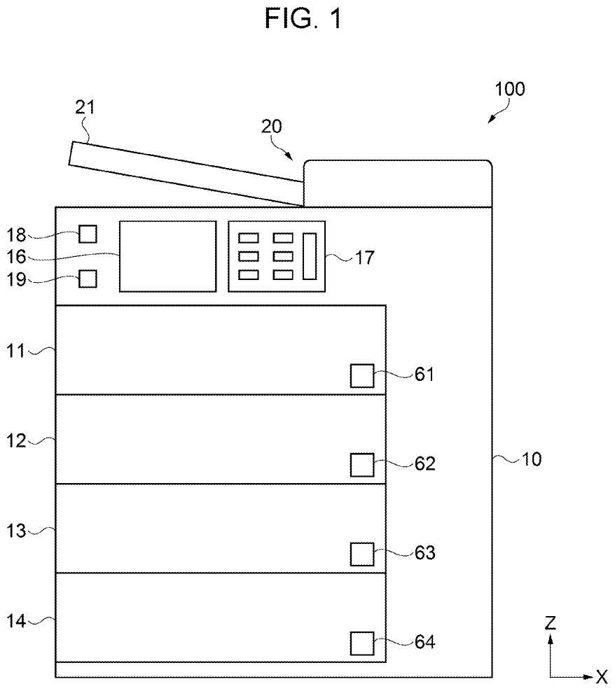

As illustrated in FIG. 1, the sorting apparatus 100 has a case 10 and a paper supply section 20 that supplies paper P, which is sheet-like paper. The case 10 is formed like a rectangular parallelepiped elongated in the Z direction. The paper supply section 20 is disposed on the case 10. The case 10 has a first paper ejection cassette 11, a second paper ejection cassette 12, a third paper ejection cassette 13, and a fourth paper ejection cassette 14, each of which is formed like a box and is one of a plurality of mounting sections in which sorted paper P is stacked. The first to fourth paper ejection cassettes 11 to 14 are stacked in four stages from the bottom of the case 10. They are provided so as to be insertable into and removable from the case 10 as with a pull-out drawer. The first to fourth paper ejection cassettes 11 to 14 respectively have indicating sections 61 to 64 indicating that paper P has been fully mounted. Each of the indicating sections 61 to 64 has a light-emitting diode (LED), a speaker that produces a sound, or the like.

A display section 16 and an input section 17 are provided in a vertical space between the paper supply section 20 and the first paper ejection cassette 11. The input section 17 has a plurality of operation buttons to make an input. During the start of sorting of paper P, various conditions are input through the input section 17. The display section 16 is a liquid crystal display, an organic electroluminescent (EL) display, or the like. On the display section 16, an input operation to be made on the input section 17 is guided or an input made on the input section 17 is displayed. A start button 18 to start sorting of paper P by the sorting apparatus 100 and a stop button 19 to terminate the sorting of paper P are provided on the left side of the display section 16. The display section 16, input section 17, start button 18, and stop button 19 may be integrally formed as a touch panel display.

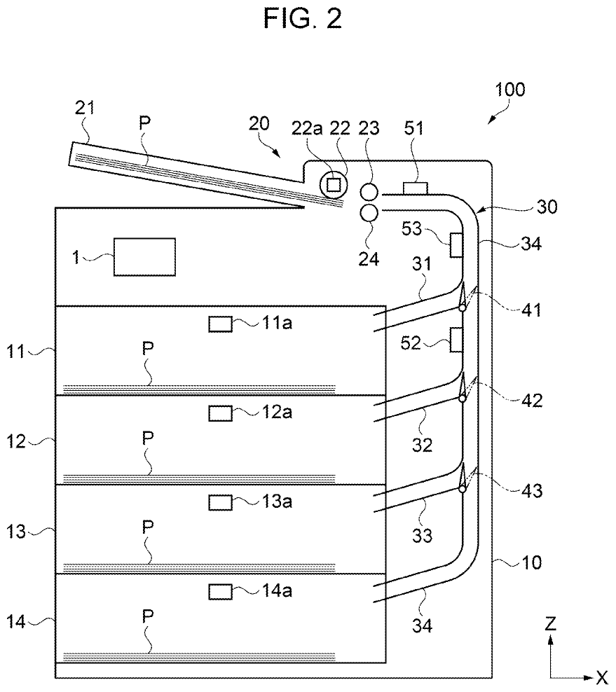

As illustrated in FIG. 2, the paper supply section 20 has a paper supply tray 21, on which paper P, which is sheet paper, to be sorted is mounted, a pick-up roller 22, a separate roller 23, a retard roller 24, and the like.

The pick-up roller 22 is positioned above the downstream end of paper P mounted on the paper supply tray 21 in a transport direction so that the pick-up roller 22 feeds the paper P from the paper supply tray 21. When the pick-up roller 22 is rotated while in contact with the upper surface of the paper P, the pick-up roller 22 takes the paper P out. The separate roller 23 and retard roller 24 are disposed downstream of the pick-up roller 22 so as to face each other vertically. When the separate roller 23 and retard roller 24 are rotated while they hold the paper P taken out of the paper supply tray 21 by the pick-up roller 22, they feed the paper P toward the downstream of the transport direction along a transport path 30.

The separate roller 23 comes in contact with the upper surface of the paper P, with which the pick-up roller 22 is in contact on the upper surface. The retard roller 24 comes into contact with the lower surface, opposite to the upper surface, of the paper P. That is, the retard roller 24 is disposed below the separate roller 23. In FIG. 2, the rotation of both the separate roller 23 and the retard roller 24 is driven counterclockwise.

The force to drive the rotation of the separate roller 23 is stronger than the force to drive the rotation of the retard roller 24. When one sheet of paper P is fed by the pick-up roller 22, the retard roller 24 is pressed toward the separate roller 23 with the paper P intervening between them. Since the paper P is reversely rotated clockwise due to the rotation of the separate roller 23 having a stronger rotation driving force than the retard roller 24, the paper P is fed toward the downstream in the transport direction.

The retard roller 24 is formed so that it has a higher coefficient of friction on the paper P than the separate roller 23. When two sheets of paper P are fed by the pick-up roller 22, the separate roller 23 feeds only the upper paper P toward the downstream in the transport direction and the retard roller 24 feeds the lower paper P back toward the upstream in the transport direction. Thus, sheets of paper P are fed separately one sheet at a time.

The transport path 30, through which the paper P is transported in the transport direction, is disposed downstream of the separate roller 23 and retard roller 24. A plurality of transport rollers that transport the paper P through the transport path 30 are provided beside the transport path 30. The transport path 30 includes a first switching section 41, a second switching section 42, and a third switching section 43 that appropriately transport the paper P to the first to fourth paper ejection cassettes 11, 12, 13, and 14.

The transport path 30 is composed of a main transport path 34 extending from the separate roller 23 to the fourth paper ejection cassette 14, a first branch path 31 branching from the main transport path 34 and extending to the first paper ejection cassette 11, a second branch path 32 branching from the main transport path 34 and extending to the second paper ejection cassette 12, and a third branch path 33 branching from the main transport path 34 and extending to the third paper ejection cassette 13.

The first switching section 41 is a movable flap disposed at the branch point between the main transport path 34 and the first branch path 31. The first switching section 41 is structured so that it can move to a position at which the first switching section 41 closes a port led to the first branch path 31 and to a position at which the first switching section 41 closes the main transport path 34. When the first switching section 41 moves to the position at which it closes the main transport path 34, the paper P branches from the main transport path 34 to the first branch path 31 and is then stacked in the first paper ejection cassette 11. When the first switching section 41 moves to the position at which it closes the port led to the first branch path 31, the paper P is transported toward the downstream of the main transport path 34.

The second switching section 42, positioned downstream of the first switching section 41, is a movable flap disposed at the branch point between the main transport path 34 and the second branch path 32. The second switching section 42 is structured so that it can move to a position at which the second switching section 42 closes a port led to the second branch path 32 and to a position at which the second switching section 42 closes the main transport path 34. When the second switching section 42 moves to the position at which it closes the main transport path 34, the paper P branches from the main transport path 34 to the second branch path 32 and is then stacked in the second paper ejection cassette 12. When the second switching section 42 moves to the position at which it closes the port led to the second branch path 32, the paper P is transported toward the downstream of the main transport path 34.

The third switching section 43, positioned downstream of the second switching section 42, is a movable flap disposed at the branch point between the main transport path 34 and the third branch path 33. The third switching section 43 is structured so that it can move to a position at which the third switching section 43 closes a port led to the third branch path 33 and to a position at which the third switching section 43 closes the main transport path 34. When the third switching section 43 moves to the position at which it closes the main transport path 34, the paper P branches from the main transport path 34 to the third branch path 33 and is then stacked in the third paper ejection cassette 13. When the third switching section 43 moves to the position at which it closes the port led to the third branch path 33, the paper P is transported toward the downstream of the main transport path 34 and is then stacked in the fourth paper ejection cassette 14.

Next, sensors provided in section in the sorting apparatus 100 will be described.

A first sensor 51 that detects a multi-feed of paper P supplied from the paper supply section 20 is provided downstream of the separate roller 23. The first sensor 51 can be an ultrasonic sensor having a generator that generates ultrasound and a receiver that receives the ultrasound. The generator is disposed at a position at which it faces one surface of the paper P on the main transport path 34. The receiver is disposed at a position at which it faces the other surface of the paper P on the main transport path 34. A multi-feed of paper P can be detected from an amount by which the ultrasound that has passed through the paper P is attenuated, the amount being measured by the ultrasonic sensor.

A second sensor 52 that detects damage to paper P is provided between the first switching section 41 and the second switching section 42 on the main transport path 34. The second sensor 52 can be a reflective optical sensor having a light-emitting portion, such as an LED or a laser, that emits light and a light-receiving portion that receives reflected light due to light emitted from the light-emitting portion and then reflected. A plurality of optical sensors are preferably provided on a side on which they face one surface of the paper P on the main transport path 34, so as to be aligned in the width direction of the paper P. A light absorbing body that suppresses reflection of light is provided on a side on which the light absorbing body faces the other surface of the paper P on the main transport path 34. The light absorbing body can be formed by using a black sheet, a paint that absorbs light, or the like. Damage to the paper P can be detected from the amount of received reflected light measured by the optical sensor.

A third sensor 53 that detects the paper P as an image is provided between the first sensor 51 and second sensor 52 on the main transport path 34. That is, beside the main transport path 34, the first sensor 51, third sensor 53, and second sensor 52 are disposed in that order from the upstream toward the downstream in the transport direction in which the paper P is transported. The third sensor 53 is an image sensor such as a complementary metal-oxide-semiconductor (CMOS) sensor included in a scanner. The image sensor receives reflected light of light emitted to the paper P and coverts information about an image of the paper P to electric signals. A plurality of images sensors are provided on a side on which they face one surface of the paper P on the main transport path 34, so as to be aligned in the width direction of the paper P. Image sensors may be provided on both sides on which they face both sides of the paper P on the main transport path 34. The positions, indicated in this embodiment, at which the first to third sensors 51, 52, and 53 are disposed are just an example. It is only needed that the first sensor 51 is disposed upstream of the first switching section 41, the second sensor 52 is disposed downstream of the first sensor 51 and upstream of the second switching section 42, and the third sensor 53 is disposed downstream of the first sensor 51 and upstream of the third switching section 43.

A fourth sensor 22a is attached to the pick-up roller 22. The fourth sensor 22a detects the torque of the pick-up roller 22 when the paper P is fed. The fourth sensor 22a is a current sensor that measures a current flowing in a motor that drives the rotation of the pick-up roller 22. The torque of the pick-up roller 22 can be detected from the amount of current measured by the current sensor.

Paper-full sensors 11a to 14a are respectively attached to the first to fourth paper ejection cassettes 11, 12, 13, and 14 to detect that they have been filled with a stack of paper P. The paper-full sensors 11a to 14a can be each a transmission optical sensor having a light-emitting portion, such as an LED or a laser, that emits light and a light-receiving portion that receives light emitted from the light-emitting portion. A light-emitting section and its corresponding light receiving section are attached to upper portions of opposing inner walls of each of the first to fourth paper ejection cassettes 11, 12, 13, and 14. When paper P is stacked and light from the light-emitting portion thereby shuts off light from the light-emitting portion, the amount of received light measured by the light-receiving portion is reduced. Thus, it can be detected that the paper ejection cassette has been filled with paper P.

The sorting apparatus 100 has a control section 1 that controls the sections described above.

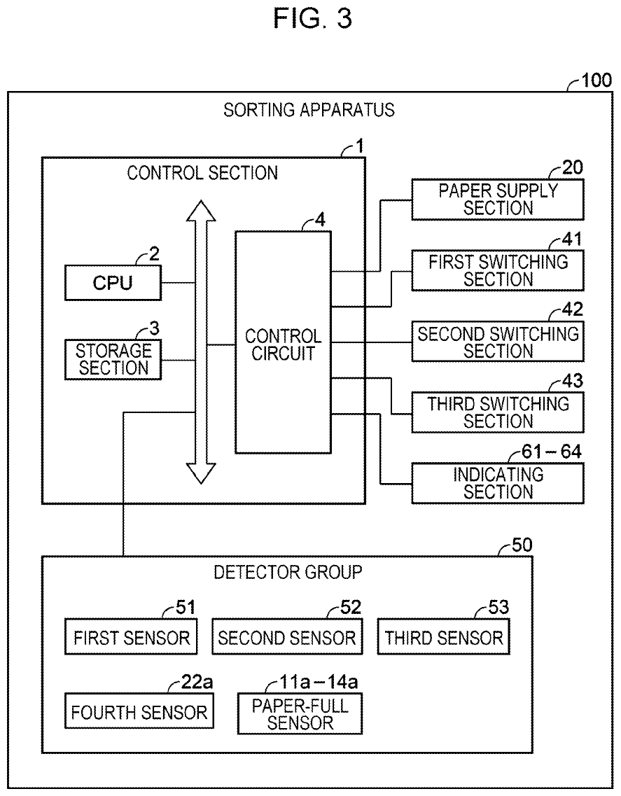

As illustrated in FIG. 3, the control section 1 has a central processing unit (CPU) 2, a storage section 3, a control circuit 4, and the like. The CPU 2 is coupled to the storage section 3, control circuit 4, and the like through a bus. The CPU 2 is also coupled through the bus to a detector group 50 including the first sensor 51, second sensor 52, third sensor 53, fourth sensor 22a, and paper-full sensors 11a to 14a.

The CPU 2 is an arithmetic processing apparatus that processes various input signals and controls the whole of the sorting apparatus 100 according to programs stored in the storage section 3.

The storage section 3 is a storage medium in which a work area, an area in which the programs used by the CPU 2 are stored, and the like are allocated. The storage section 3 has a random-access memory (RAM), an electrically erasable programmable read-only memory (EEPROM), and other storage elements.

The control circuit 4, which is coupled to the paper supply section 20, first switching section 41, second switching section 42, third switching section 43, and indicating sections 61 to 64, creates control signals that control the driving of these sections.

Each of the first sensor 51, second sensor 52, third sensor 53, fourth sensor 22a, and paper-full sensor 11a to 14a outputs, as an output signal, a result detected by the sensor.

The control section 1 controls the first to third switching sections 41 to 43 so that paper P is ejected to the proper paper ejection cassette 11, 12, 13, or 14 according the detection result from at least one of the first sensor 51, second sensor 52, and third sensor 53.

The control section 1 controls the driving of the retard roller 24 according to the detection result from the fourth sensor 22a, which detects the torque of the pick-up roller 22 included in the paper supply section 20.

The control section 1 drives the indicating sections 61 to 64 attached to the corresponding first paper ejection cassettes 11 to 14, according to the detection results from the paper-full sensors 11a to 14a.

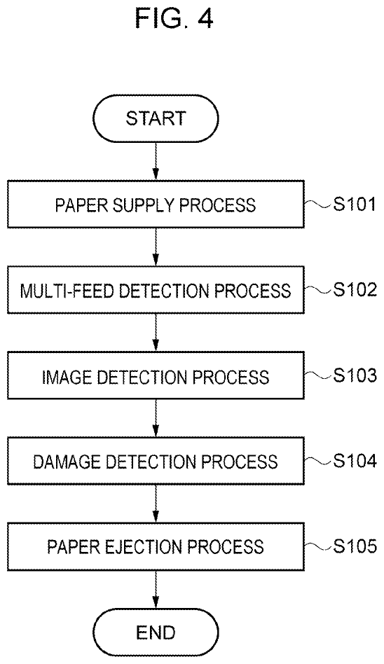

Next, a method of sorting paper P by using the sorting apparatus 100 will be described with reference to FIG. 4. The sorting method in this embodiment starts when paper P is stacked in the paper supply tray 21 and the start button 18 is then pressed.

Step S101 is a paper supply process in which paper P is supplied. The control section 1 controls the pick-up roller 22, separate roller 23, and retard roller 24 so that paper P stacked on the paper supply tray 21 is fed to the transport path 30. The control section 1 also receives an output signal from the fourth sensor 22a, and when the torque of the pick-up roller 22 is higher than or equal to a predetermined value, switches to driving by which the retard roller 24 is reversely rotated clockwise. If, for example, a plurality of sheets of paper P are fastened at the upstream end of the paper P with a stapler or another fastener, a paper jam may occur at the paper supply section 20. With the sorting apparatus 100 in this embodiment, when paper P is taken out, the torque of the pick-up roller 22 is detected. When the detected torque is higher than or equal to the predetermined value, the sorting apparatus 100 decides that the paper P is fastened with a fastener and thereby reversely rotates the retard roller 24. Therefore, it is possible to concurrently feed out a plurality of sheets of paper P fastened with a fastener without a paper jam.

Step S102 is a multi-feed detection process in which a multi-feed of paper P supplied from the paper supply section 20 is detected. The control section 1 receives an output signal from the first sensor 51. When there is a multi-feed of paper P, an amount by which ultrasound that has passed through the paper P is attenuated is large. Therefore, whether there is a multi-feed of paper P can be detected.

Step S103 is an image detection process in which the paper P is detected as an image. The control section 1 receives an output signal from the third sensor 53 and creates image data of the paper P. The control section 1 acquires pixel data of the base color of the paper P from the image data of the paper P, and determines a threshold value based on the pixel data of the base color.

Specifically, the control section 1 acquires a plurality of pixel data items for the base of the paper P, averages them, and takes the average as the pixel data of the base color. In this case, pixel data including abnormality such as dirt is excluded. Pixel data is represented as, for example, a 256-level gray scale in a red-green-blue (RGB) color space. The control section 1 determines the threshold value through a calculation expression in which a predetermined coefficient is used.

The control section 1 extracts pixel data in a non-recorded area from the image of the paper P, and binarizes the pixel data in the non-recorded area to two values, white and black, according to the threshold value. In the description below, pixel data converted to black as the result of binarization will also be referred to as a white pixel and pixel data converted to white will also be referred to as a white pixels. In the non-recoded area, printing has not been performed on the paper P. The non-recorded area may be identified from the image of the paper P or may be determined from coordinate data, entered from the input section 17, that identifies the non-recorded area. The control section 1 calculates the ratio of black pixels in the pixel data binarized to white and black. Recycled paper produced by a dry recycled paper producing apparatus has a plurality of characteristic tiny stains. A pixel having a tiny stain is binarized to a black pixel, so it is possible to detect whether the paper P is recycled paper or non-recycled paper according to the ratio of black pixels.

Step S104 is a damage detection process in which damage to the paper P is detected. The control section 1 receives the amount of received light detected by the second sensor 52. When the paper P has damage, light emitted from the light emitting portion attenuates in the light absorbing body by passing through the damaged portion. Thus, the amount of light received in the light receiving portion is greatly small, making it possible to detect damage to the paper P.

Step S105 is a paper ejection process in which the paper P is appropriately ejected to one of the first to fourth paper ejection cassettes 11, 12, 13, and 14. The control section 1 controls the first to third switching sections 41 to 43 according to at least one of detection results from the first sensor 51, second sensor 52, and third sensor 53.

First, the control section 1 decides whether there is a multi-feed of paper P. When the control section 1 decides, from the output signal from the first sensor 51, that there is a multi-feed of paper P, the control section 1 causes the first switching section 41 to move to the position at which the first switching section 41 closes the main transport path 34 and opens the first branch path 31. Thus, the paper P fastened with a fastener is ejected to the first paper ejection cassette 11. When the control section 1 decides that there is a multi-feed of paper P, steps S103 and S104 may be skipped.

Next, the control section 1 decides whether the paper P has damage. When the control section 1 decides, from the output signal from the second sensor 52, that the paper P has damage, the control section 1 causes the second switching section 42 to move to the position at which the second switching section 42 closes the main transport path 34 and opens the second branch path 32. Thus, the paper P having damage is ejected to the second paper ejection cassette 12.

Next, the control section 1 decides whether the paper P is recycled paper or non-recycled paper. When the control section 1 decides, from the calculated ratio of black pixels, that the paper P is recycled paper, the control section 1 causes the third switching section 43 move to the position at which the third switching section 43 closes the main transport path 34 and opens the third branch path 33. Thus, the paper P decided to be recycled paper is ejected to the third paper ejection cassette 13. When the paper P is decided to be non-recycled paper, the third switching section 43 is positioned at the position at which the third switching section 43 closes the third branch path 33 and opens the main transport path 34. Therefore, the paper P, which is non-recycled paper, is ejected to the fourth paper ejection cassette 14.

The control section 1 executes steps S101 to S105 once for each sheet of paper P. When the control section 1 receives, from one of the paper-full sensors 11a to 14a, an output signal indicating that paper P has been fully mounted, the control section 1 drives the relevant indicating section 61, 62, 63, or 64 attached to the relevant paper ejection cassette 11, 12, 13, or 14.

When the control section 1 detects that there is no more paper P on the paper supply tray 21 or that the stop button 19 has been pressed, the control section 1 terminates this flow.

The sorting apparatus 100 and sorting method may have various other sorting functions. In an example of possible sorting, the color or print ratio of paper P or its dirt is detected from the image data of the paper P to remove paper inappropriate as a raw material of recycled paper.

In this embodiment, the sorting apparatus 100 has been exemplified that has, as mounting sections in which the paper P is stacked, the first to fourth paper ejection cassettes 11 to 14 formed so as to be insertable into and removable from the case 10 as with a pull-out drawer. However, the sorting apparatus 100 may be structured so that paper P is stacked on a plurality of paper ejection trays provided so as to protrude from the case 10.

As described above, the sorting apparatus 100 according to this embodiment provides effects described below.

A sorting apparatus 100 has a first sensor 51 and a second sensor 52. The first sensor 51 detects a multi-feed of paper P, which is fastened with a fastener, for example. The second sensor 52 detects paper P having damage. Therefore, it is possible to sort paper P that may cause a paper jam before the paper P is supplied to a recycled paper producing apparatus. The sorting apparatus 100 also has a third sensor 53. According to the image data of the paper P detected by the third sensor 53, it is possible to sort the paper P as recycled paper or non-recycled paper. Therefore, the sorting apparatus 100 can be provided to sort paper P to be used in a recycled paper producing apparatus that supplies sheet-like paper P as a raw material.

The sorting apparatus 100 has first to third switching sections 41 to 43 through which paper P is appropriately transported to one of the first to fourth paper ejection cassettes 11 to 14, each of which is a mounting section. Since the control section 1 controls the first to third switching sections 41 to 43 according to detection results from the first to third sensors 51 to 53, the control section 1 can sort paper P and can appropriately eject the sorted paper P to one of the first to fourth paper ejection cassettes 11 to 14.

The third sensor 53 is disposed between the first sensor 51 and the second sensor 52. It takes much time to process image data created from an output signal from the third sensor 53. In view of this, the third sensor 53 is disposed upstream of the second sensor 52 to assure processing time.

Since the first sensor 51 is an ultrasonic sensor, it is possible to preferably detect a multi-feed of paper P from an amount by which ultrasound that has passed through the paper P is attenuated. Since the second sensor 52 is an optical sensor, it is possible to preferably detect damage to the paper P from the amount of light reflected on the paper P. Since the third sensor 53 is an image sensor, it is possible to easily read the paper P.

The sorting apparatus 100 has a fourth sensor 22a that detects the torque of the pick-up roller 22. When a plurality of sheets of paper P are fastened with a fastener at the upstream end of the paper P, a paper jam may occur in the paper supply section 20. Since the sorting apparatus 100 detects the torque of the pick-up roller 22 by using the fourth sensor 22a, the sorting apparatus 100 can detect paper P that may cause a paper jam in advance.

The control section 1 determines a threshold value based on pixel data of the base color of paper P, and binarizes pixel data in a non-recorded area according to the threshold value. Recycled paper produced by a dry recycled paper producing apparatus has characteristic tiny stains. A pixel having a tiny stain is binarized to a black pixel, so it is possible to detect whether the paper P is recycled paper or non-recycled paper according to the ratio of black pixels.

A sorting method includes a multi-feed process and a damage detection process. In the multi-feed process, a multi-feed of paper P, which is fastened with a fastener, for example, is detected. In the damage detection process, paper P having damage is detected. Therefore, it is possible to sort paper P that may cause a paper jam before the paper P is supplied to a recycled paper producing apparatus. The sorting method also includes an image detection process. According to the image data, created in the image detection process, of the paper P, it is possible to sort the paper P as recycled paper or non-recycled paper. Therefore, the sorting method can be provided to sort paper P to be used in a recycled paper producing apparatus that supplies sheet-like paper P as a raw material.

What is claimed is:

1. A sorting apparatus comprising:
a paper supply section that supplies paper;
a first sensor that detects a multi-feed of the paper supplied from the paper supply section;
a second sensor that detects damage to the paper;
a third sensor that detects the paper as an image;
a plurality of mounting sections in which the paper is stacked; and
a control section that appropriately ejects the paper to one of the mounting sections according to at least one of detection results from the first sensor, the second sensor, and the third sensor.

2. The sorting apparatus according to claim 1, further comprising a plurality of switching sections that appropriately transport the paper to the mounting sections, wherein the control section controls the switching sections according to the at least one of the detection results.

3. The sorting apparatus according to claim 2, wherein the first sensor, the third sensor, and the second sensor are disposed sequentially from an upstream toward a downstream in a transport direction in which the paper is transported, the first sensor being disposed at the upstream followed by the third sensor and then by the second sensor.

4. The sorting apparatus according to claim 1, wherein:
the first sensor is an ultrasonic sensor;
the second sensor is an optical sensor; and
the third sensor is an image sensor.

5. The sorting apparatus according to claim 1, wherein the paper supply section has a pick-up roller that takes the paper out, the apparatus further comprising a fourth sensor that detects a torque of the pick-up roller when the paper is fed.

6. The sorting apparatus according to claim 1, wherein the control section
acquires pixel data of a base color of the paper from the image of the paper, the image being detected by the third sensor, and determines a threshold value based on the pixel data of the base color,
extracts pixel data in a non-recorded area from the image of the paper, and binarizes pixel data in the non-recorded area to two values, white and black, according to the threshold value, and
decides whether the paper is recycled paper from a ratio of the black in the binarized pixel data.

7. A sorting method in which the sorting apparatus described according to claim 1 is used to sort the paper, the method comprising:
a paper supply step of supplying the paper;
a multi-feed detection step of detecting a multi-feed of the paper supplied from the paper supply section;
a damage detection step of detecting damage to the paper;
an image detection step of detecting the paper as an image; and
a paper ejection step of appropriately ejecting the paper to one of the mounting sections according to at least one of detection results from the first sensor, the second sensor, and the third sensor.
